(19) United States
(12) Patent Application Publication
(10) Pub. No.: US 2024/0429518 A1
(43) Pub. Date: Dec. 26, 2024

(54) BATTERY PACK FOR ELECTRIFIED VEHICLE HAVING VIBRATION RESISTANT HOLDING PAD WITH DOUBLE SIDED GLUE

(71) Applicant: FCA US LLC, Auburn Hills, MI (US)

(72) Inventors: Juanxia Dong, Shanghai (CN); Zi Ye Wang, Shanghai (CN); Xingjia Li, Shanghai (CN); Deming Leo Luo, Shanghai (CN); Xiu Min Song, Shanghai (CN)

(21) Appl. No.: 18/340,404

(22) Filed: Jun. 23, 2023

(51) Int. Cl. H01M 50/242; B60L 50/64; H01M 10/613; H01M 10/625; H01M 10/6554; H01M 50/204; H01M 50/227; H01M 50/249; H01M 50/258

(52) U.S. Cl. CPC H01M 50/242; B60L 50/64; H01M 10/613; H01M 10/625; H01M 10/6554; H01M 50/204; H01M 50/227; H01M 50/249; H01M 50/258; H01M 2220/20

(57) ABSTRACT

A battery pack assembly for an electrified vehicle includes a main body assembly comprising a structural frame support assembly. The structural frame support assembly includes a first floor module support frame, a first floor cooling plate, a second floor module support frame, a second floor cooling plate and a holding pad. The second floor module support frame can support an upper battery housing. The holding pad can be disposed between the second floor module support frame and the second floor cooling plate. The holding pad can have first structural glue disposed thereon between the holding pad and the second floor cooling plate. The holding pad can further have second structural glue disposed between the holding pad and the second floor module support frame. The first and second structural glue inhibits relative movement between the second floor cooling plate, holding pad and second floor module support frame.

### FIELD

The present application generally relates to electrified vehicles and, more particularly, to a battery pack incorporating a vibration resistant holding pad with double sided glue.

### BACKGROUND

An electrified vehicle (hybrid electric, plug-in hybrid electric, range-extended electric, battery electric, etc.) includes at least one battery system and at least one electric motor. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor.

The high voltage battery system generally includes a battery pack assembly that includes a housing that houses one or more battery packs. Typically, the battery pack assembly includes a cooling system wherein a cooling liquid is circulated along a cooling plate for cooling the battery packs and the battery pack assembly. In some instances, vehicle vibration and/or impact loads experienced during driving can cause deformation of battery pack components including the cooling plate and the battery pack assembly as a whole. Accordingly, while such conventional battery pack assemblies do work well for their intended purpose, there exists an opportunity for improvement in the relevant art.

### SUMMARY

According to one example aspect of the invention, a battery pack assembly for an electrified vehicle includes a main body assembly comprising a structural frame support assembly. The structural frame support assembly includes a first floor module support frame, a first floor cooling plate, a second floor module support frame, a second floor cooling plate and a holding pad. The first floor module support frame supports a lower battery housing. The first floor cooling plate can be supported by the first floor module support frame. The second floor module support frame can support an upper battery housing. The second floor cooling plate can be supported by the second floor module support frame. The holding pad can be disposed between the second floor module support frame and the second floor cooling plate. The holding pad can have first structural glue disposed thereon between the holding pad and the second floor cooling plate. The holding pad can further have second structural glue disposed thereon between the holding pad and the second floor module support frame. The first and second structural glue inhibits relative movement between the second floor cooling plate, holding pad and second floor module support frame.

In some implementations, the first structural glue can comprise double-sided glue. In additional implementations, the second structural glue can comprise double-sided glue. Thermal glue can be disposed between the second floor cooling plate and the structural support frame assembly. The structural frame support assembly can further comprise a front beam, a rear beam, a first side beam and a second side beam.

According to another example aspect of the invention, a plurality of first floor cooling plates can be provided that occupy a first layer in the main body assembly. The second floor module can be arranged generally parallel and offset relative to the first floor module support frame.

In some implementations, the holding pad can be formed of a vibration resistant material. In some examples, the holding pad can be formed of expanded polypropylene. In other examples, the holding pad can be formed of EPP90.

A battery pack assembly for an electrified vehicle according to additional examples of the present disclosure includes a main body assembly comprising a structural frame support assembly. The structural frame support assembly includes a first floor module support frame, a first floor cooling plate, a second floor module support frame, a second floor cooling plate, a holding pad, first double-sided tape and second double-sided tape. The first floor module support frame supports a lower battery housing. The first floor cooling plate can be supported by the first floor module support frame. The second floor module support frame can support an upper battery housing. The second floor cooling plate can be supported by the second floor module support frame. The holding pad can be disposed between the second floor module support frame and the second floor cooling plate. The first double-sided tape can be disposed between the holding pad and the second floor cooling plate. The first double-sided tape can inhibit relative movement between the holding pad and the second floor cooling plate. The second double-sided tape can be disposed between the holding pad and the second floor module support frame. The second double-sided tape can inhibit relative movement between the holding pad and the second floor module support frame.

In additional arrangements thermal glue can be disposed between the second floor cooling plate and the structural support frame assembly. The structural frame support assembly can further comprise a front beam, a rear beam, a first side beam and a second side beam.

According to another example aspect of the invention, a plurality of first floor cooling plates can be provided that occupy a first layer in the main body assembly. The second floor module can be arranged generally parallel and offset relative to the first floor module support frame.

In some implementations, the holding pad can be formed of a vibration resistant material. In some examples, the holding pad can be formed of expanded polypropylene. In other examples, the holding pad can be formed of EPP90.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having a battery system including a battery pack assembly according to the principles of the present application;

FIG. 2 is front perspective view of a main body assembly of the battery pack assembly of the battery system of FIG. 1 according to the principles of the present application;

FIG. 3 is a top view of the main body assembly of FIG. 2 according to the principles of the present application;

FIG. 4 is a sectional view of the main body assembly taken along lines 4-4 of FIG. 3 according to the principles of the present application;

FIG. 5 is a detail view of the main body assembly taken around area 5 of FIG. 4 according to principles of the present application;

FIG. 6 is a detail view of the main body assembly taken around area 6 of FIG. 4 according to principles of the present application; and

FIG. 7 is a detail view of the main body assembly taken around area 7 of FIG. 4 according to principles of the present application.

### DESCRIPTION

As discussed above, a high voltage battery system generally includes a battery pack assembly that includes a housing that houses one or more battery packs. Typically, the battery pack assembly includes a cooling system wherein a cooling liquid is circulated along a cooling plate for cooling the battery packs and the battery pack assembly. In some battery pack assemblies, there are multiple cooling plates arranged in multiple layers withing the battery pack assembly. In some instances, vehicle vibration and/or impact loads experienced during driving of the vehicle can cause undesirable relative movements of components in a battery pack such as frame members and cooling plates. Over the life of a vehicle, such repeated vibrations experienced by the battery packs can lead to deformation of battery pack components including the cooling plate. Over time, such vibrations can ultimately lead to failure of one or more components of the battery pack such as a rupture of one of the cooling plates.

Accordingly, the structural frame support configuration of the battery pack of the instant disclosure incorporates holding pads coated with double-sided structural glue at strategic areas to inhibit relative movements between adjacent components. In particular, the present disclosure provides an integrated design that ensures the transmission of vibration or impact loads in a more uniform manner mitigating any potential damage to the components of the battery pack including the cooling plates during the life of the vehicle. As a result, the overall anti-impact and vibration absorption ability of the battery pack as a whole is effectively enhanced.

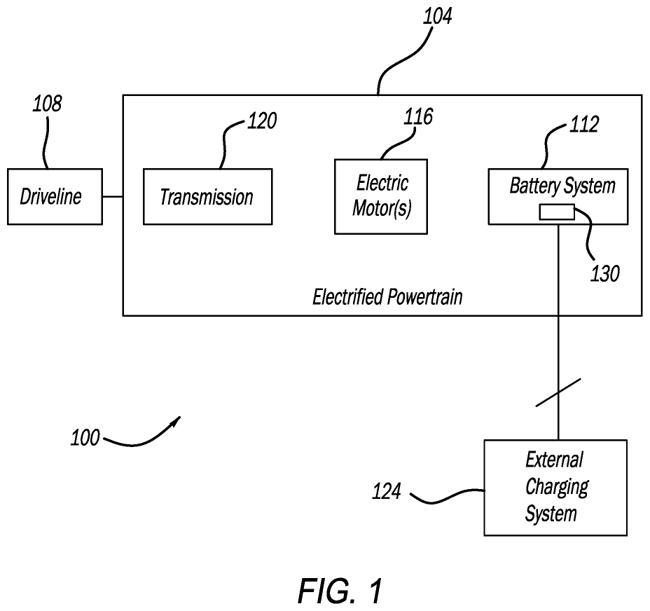

Referring now to FIG. 1, a functional block diagram of an example electrified vehicle 100 (also referred to herein as “vehicle 100”) according to the principles of the present application is illustrated. The vehicle 100 includes an electrified powertrain 104 configured to generate and transfer drive torque to a driveline 108 of the vehicle 100 for propulsion. The electrified powertrain 104 generally comprises a high voltage battery system 112 (also referred to herein as “battery system 112”), one or more electric motors 116, and a transmission 120. The battery system 112 is selectively connectable (e.g., by the driver) to an external charging system 124 (also referred to herein as “charger 124”) for charging of the battery system 112. The battery system 112 includes at least one battery pack assembly 130.

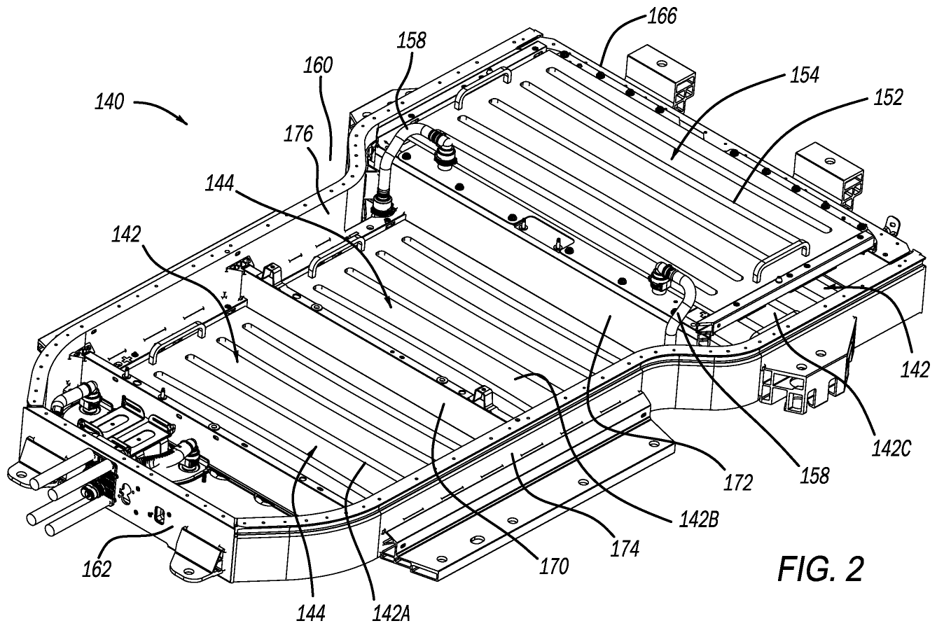

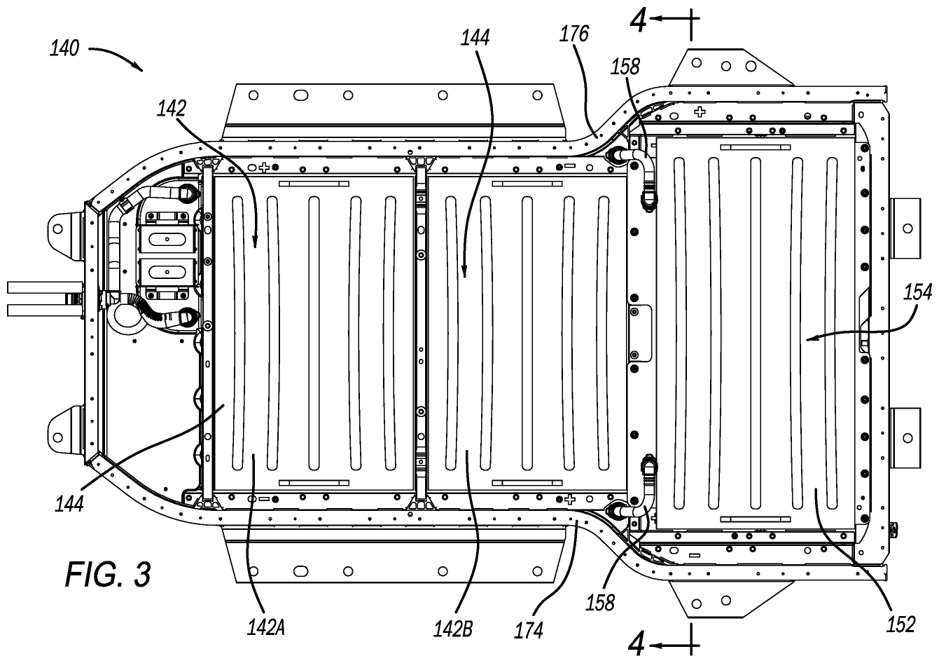

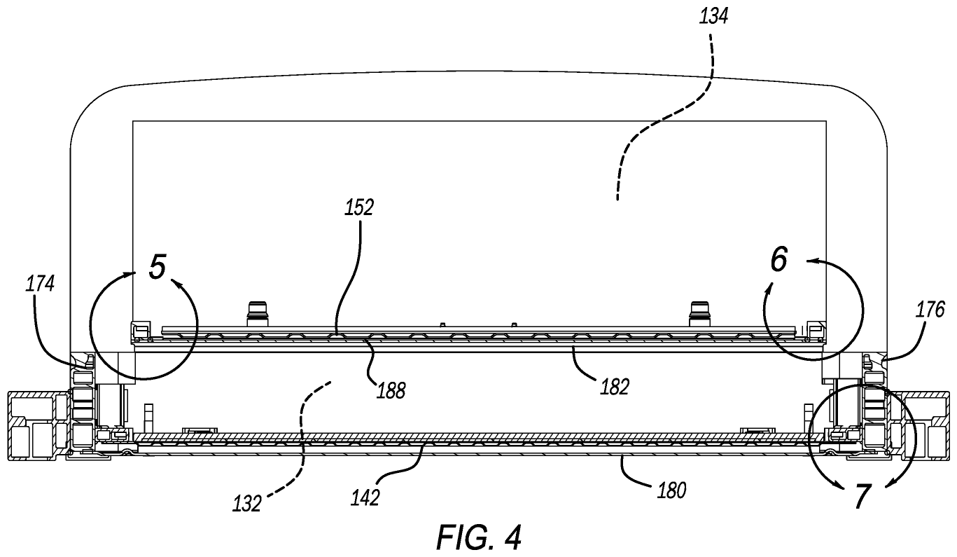

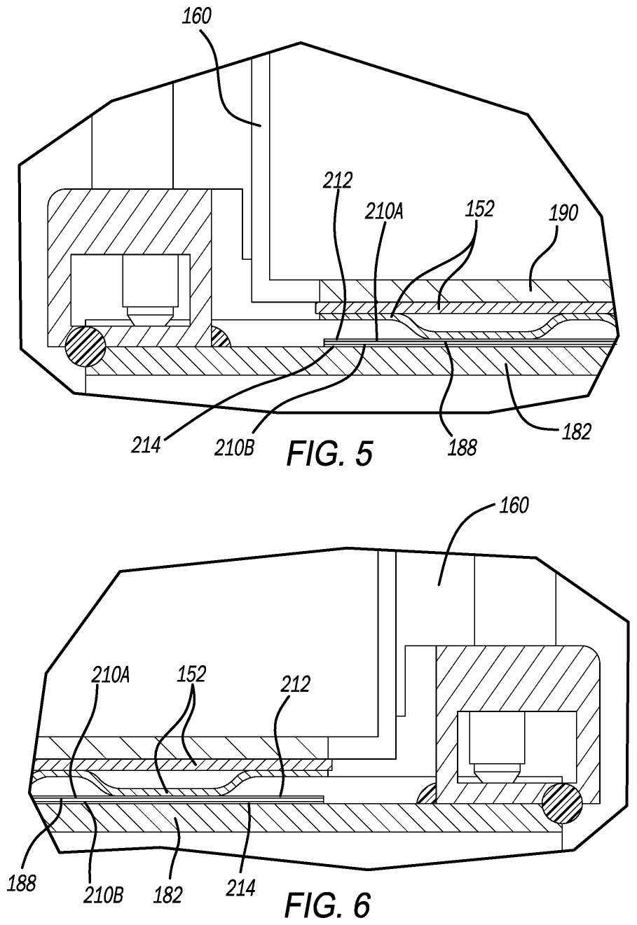

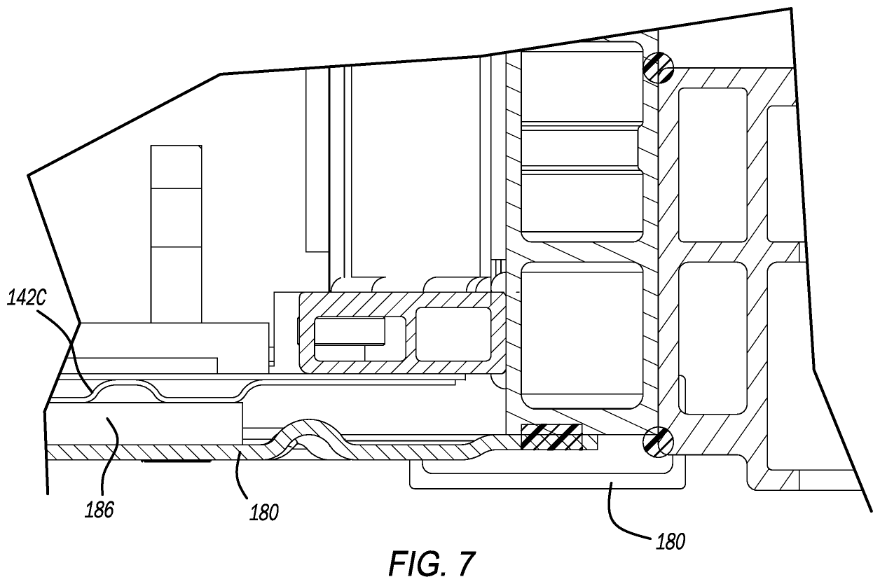

Referring now to FIGS. 2-7, additional features of the instant battery pack assembly 130 will be described. In examples, the battery pack assembly 130 can generally include a lower battery housing 132 and an upper battery housing 134. The battery pack assembly 130 according to one example of the present disclosure includes a main body assembly 140. The main body assembly 140 generally represents the battery pack assembly 130 with the batteries removed for illustration purposes. In general, however, the battery pack assembly 130 can include a lower battery housing 132 and an upper battery housing 134. Batteries, not specifically shown, are generally housed in the battery pack assembly 130 under a top cover (not shown).

The main body assembly 140 further houses a plurality of first floor cooling plates collectively identified at 142 and individually identified at references 142A, 142B and 142C. The first floor cooling plates 142 occupy a first layer 144 in the main body assembly 140. In addition, the main body assembly 140 houses a second floor cooling plate 152 that occupies a second layer 154 within the main body assembly 140. In examples, the first and second layers 144 and 154 of cooling plates 142 and 152 are parallel and offset. The cooling plates 142 and 152 are configured to cool components of the battery pack assembly 130 by routing cooling fluid through various internal passages withing the cooling plates 142 and 152. Cooling fluid can be routed between the various cooling plates 142 and 152 by fluid tubes 158.

The main body assembly 140 of the battery pack assembly 130 according to some implementations of the present application generally includes a structural frame support assembly 160. The structural support frame assembly 160 can include a front beam 162, a rear beam 166, a first intermediate beam 170, a second intermediate beam 172, a first side beam 174 and a second side beam 176. The structural support frame assembly 160 can further include a first floor module support frame or bottom plate 180 and a second floor module support frame 182. In examples, the second floor module support frame 182 can be arranged generally parallel and offset relative to the first floor module support frame 182. In examples, the first floor module support frame 180 can support the lower battery housing 132. Further, the first floor module support frame 180 can support the first floor cooling plates 142.

The second floor module support frame 182 can support the upper battery housing 134. Further, the second floor module support frame 182 can support the second floor cooling plate 152. A first floor holding pad 186 is disposed between the first floor module support frame 180 and the cooling plate 142C. A second floor holding pad 188 is disposed between the second floor module support frame 182 and the cooling plate 152. The first and second floor holding pads 186 and 188 can be formed of vibration resistant material such as, but not limited to, expanded polypropylene such as EPP90. Thermal glue 190 is disposed between the cooling plate 152 and the frame assembly 160.

According to the present disclosure, structural glue 210A is disposed on a first side 212 of the holding plate 188. Structural glue 210B is similarly disposed on a second side 214 of the holding pad 188. The structural glue 210A forms a bond between the cooling plate 152 and the holding pad 188. The structural glue 210B forms a bond between the holding plate 188 and the second floor module support frame 182. In examples, the structural glue 210A and 210B can each be a sheet of material having glue disposed on opposite sides, otherwise referred to as “double-sided” glue or tape. In other examples, the structural glue 210A and 210B can simply be exclusively a layer of glue.

The resulting structure of the cooling plate 152, the holding pad 188 having structural glue 210A, 210B and the second floor module support frame 182 resists relative movement between the cooling plate 152, the holding pad 188 and the second floor module support frame 182 thereby inhibiting transmitted vibrations experienced at the cooling plate 152 and within the battery pack assembly 130 as a whole. Explained further, the structural glue 210A inhibits relative movement between the cooling plate 152 and the holding pad 188. Similarly, the structural glue 210B inhibits relative movement between the holding pad 188 and the second floor module support frame 182. Because vibrations and impact forces are not as easily transmitted between adjacent components (e.g., the second floor module support frame 182, the holding pad 188 and the cooling plate 152), the cooling plate 152 and the second floor support module frame 182 are both less susceptible to damage such as cracking over the life of the electrified vehicle 100.

As the cooling plate 152, holding pad 188 and second floor module support frame 182 are separate components, vibration amplitudes experienced during normal driving of the electrified vehicle 100 tend to amplify without inhibiting relative movements between these components. With the structural glue 210A and 210B provided on opposite sides of the holding pad 188, vibrations are not as easily transmitted between the second floor module support frame 182 and the cooling plate 152. In this regard, the cooling plate 152 and the second floor module support frame 182 both experience minimal disruption and therefore deformations that could ultimately lead to damage during the life of the battery pack assembly 130.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A battery pack assembly for an electrified vehicle, the battery pack assembly comprising:
a main body assembly comprising a structural frame support assembly, the structural frame support assembly comprising:
a first floor module support frame that supports a lower battery housing;
a first floor cooling plate supported by the first floor module support frame;
a second floor module support frame that supports an upper battery housing;
a second floor cooling plate supported by the second floor module support frame; and
a holding pad disposed between the second floor module support frame and the second floor cooling plate, the holding pad having (i) first structural glue disposed thereon between the holding pad and the second floor cooling plate; and (ii) second structural glue disposed thereon between the holding pad and the second floor module support frame, the first and second structural glue inhibiting relative movement between the second floor cooling plate, holding pad and second floor module support frame.

2. The battery pack assembly of claim 1, wherein the first structural glue comprises double-sided glue.

3. The battery pack assembly of claim 1, wherein the second structural glue comprises double-sided glue.

4. The battery pack assembly of claim 3, further comprising:
thermal glue disposed between the second floor cooling plate and the structural support frame assembly.

5. The battery pack assembly of claim 1, wherein the structural frame support assembly further comprises a front beam, a rear beam, a first side beam and a second side beam.

6. The battery pack assembly of claim 1, further comprising a plurality of first floor cooling plates that occupy a first layer in the main body assembly.

7. The battery pack assembly of claim 1 wherein the second floor module is arranged generally parallel and offset relative to the first floor module support frame.

8. The battery pack assembly of claim 1, wherein the holding pad is formed of a vibration resistant material.

9. The battery pack assembly of claim 8, wherein the holding pad is formed of expanded polypropylene.

10. The battery pack assembly of claim 9, wherein the holding pad is formed of EPP90.

11. A battery pack assembly for an electrified vehicle, the battery pack assembly comprising:
a main body assembly comprising a structural frame support assembly, the structural frame support assembly comprising:
a first floor module support frame that supports a lower battery housing;
a first floor cooling plate supported by the first floor module support frame;
a second floor module support frame that supports an upper battery housing;
a second floor cooling plate supported by the second floor module support frame; and
a holding pad disposed between the second floor module support frame and the second floor cooling plate;
first double-sided tape disposed between the holding pad and the second floor cooling plate, the first double-sided tape inhibiting relative movement between the holding pad and the second floor cooling plate; and
second double-sided tape disposed between the holding pad and the second floor module support frame, the second double-sided tape inhibiting relative movement between the holding pad and the second floor module support frame.

12. The battery pack assembly of claim 11, further comprising:
thermal glue disposed between the second floor cooling plate and the structural support frame assembly.

13. The battery pack assembly of claim 11, wherein the structural frame support assembly further comprises a front beam, a rear beam, a first side beam and a second side beam.

14. The battery pack assembly of claim 11, further comprising a plurality of first floor cooling plates that occupy a first layer in the main body assembly.

15. The battery pack assembly of claim 11, wherein the second floor module is arranged generally parallel and offset relative to the first floor module support frame.

16. The battery pack assembly of claim 12, wherein the holding pad is formed of a vibration resistant material.

17. The battery pack assembly of claim 16, wherein the holding pad is formed of expanded polypropylene.

18. The battery pack assembly of claim 17, wherein the holding pad is formed of EPP90.
